(19) United States
(12) Patent Application Publication
(10) Pub. No.: US 2008/0177207 A1
(43) Pub. Date: Jul. 24, 2008

(54) MULTI-FUNCTION SCRAPING MASSAGER

(76) Inventor: Li-Chiao Liao, Taipei City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/625,952

(22) Filed: Jan. 23, 2007

(51) Int. Cl. A61H 7/00

(52) U.S. Cl. 601/137

(57) ABSTRACT

A multi-function scraping massager comprises a plate in the form of a crescent moon, provided at the outer surface thereof with a plurality of scraping rims, each having a degree of curvature. At one side of the plate is defined with an arc-shaped press portion, and the plate is defined at a predetermined position thereof with an arcuate grip portion for the user's comfortable griping, and is provided on its inner surface with a plurality of scraping ribs which are evenly spaced apart from each other. The scraping ribs are constructed in the form of a tapered arc, and are provided at the distal ends thereof with arc-shaped scraping edges, respectively, thereby obtaining scraping, finger pressing massage and meridians circulation and the like purposes.

### BACKGROUND OF THE INVENTION

1. Field of the Invention

The present invention relates to a meridian-circulating massager, and more particularly to a multi-function scraping massager that can obtain scraping, finger pressing massage and meridians circulation and the like purposes.

2. Description of the Prior Arts

Scraping is a conventional folk therapy, its therapeutical method includes circulating 12 meridians of human body so as to have a good meridian and blood circulation, such a therapy can be utilized to a sunstroke, various muscular pains and fatigues, a poor blood circulation, and a bed sweating, etc. However, the primary therapeutical tools contain spoons, bowls, dishes, or coins and so on, hence such improper tools easily cause damage and inconvenience.

Referring to FIG. 1, a prior art scraping bar 10, one end of which includes a curved scraping plate 11, and another end of which includes a handle 12 for the user's griping, is utilized to scrape the body, yet such a conventional scraping bar can not be adopted for acupoint massage or other usage else. In addition, this scraping bar 10 is not designed depended on the ergonomics theory, thus an operational damage is likely to occur. Also, because medical workers, e.g., therapists, always process naprapathy by their fingers, they are often unable to precisely press patients' central points of acupoints, or unable to have a suitable force exertion, and an occupational injury, such as finger pains and fatigues or tendonitis will happen.

The present invention has arisen to mitigate and/or obviate the afore-described disadvantages.

### SUMMARY OF THE INVENTION

A multi-function scraping massager formed of the materials having far infrared substances therein in accordance with the present invention comprises a plate, cross section of which is in the shape of an oval, constructed in the form of a crescent moon, and provided at the outer surface thereof with a plurality of scraping rims, each having a degree of curvature. At one side of the plate is defined with an arc-shaped press portion, and the plate is defined at a predetermined position thereof with an arcuate grip portion for the user's comfortable griping, and is provided on its inner surface with a plurality of scraping ribs which are evenly spaced apart from each other. The scraping ribs are constructed in the form of a tapered arc, and are provided at the distal ends thereof with arc-shaped scraping edges, respectively, such that the user is allowed to selectively have a scraping, finger pressing massage or meridians circulation based on different demands.

It is an objective of the present invention is to provide a multi-function scraping massager, which can achieve scraping, finger pressing massage and meridians circulation and the like purposes.

It is a further objective of the present invention is to provide a multi-function scraping massager, which the user can selectively hold the multi-function scraping massager at a suitable degree so that his fingers abut against the arcuate grip portion of the plate, thus obtaining an ergonomics comfortness purpose.

It is another objective of the present invention is to provide a multi-function scraping massager, which the user can selectively hold the multi-function scraping massager at a suitable degree so that his fingers abut against the arcuate grip portion of the plate, thus obtaining an ergonomics comfortness purpose.

Yet a further objective of the present invention is to provide a multi-function scraping massager, which if the user has long hairs, she can also use such a multi-function scraping massager as her hairpin.

Also another objective of the present invention is to provide a multi-function scraping massager that since it is formed of the materials having far infrared substances therein, it releases healthy far infrared for improving the blood circulation.

Still another objective of the present invention is to provide a multi-function scraping massager, which the distance between two respective scraping ribs is approximately in response to the distance between two respective acupoints, hence a number of meridians of the human body can be simultaneously massaged so as to have a meridian circulation effect

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a perspective view of a conventional scraping bar;

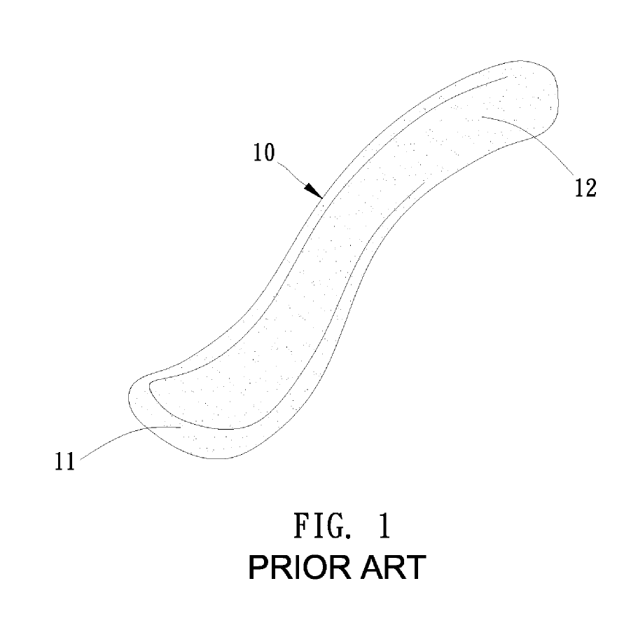

FIG. 2 is a perspective view of a multi-function scraping massager in accordance with the present invention;

FIG. 3 is a cross-sectional view of the multi-function scraping massager in accordance with the present invention;

FIG. 4 shows the multi-function scraping massager of the present invention severing to have a scraping;

FIG. 5 shows the multi-function scraping massager of the present invention severing to have another scraping;

FIG. 6 showing the meridians and acupoints of the back of human body;

FIG. 7 shows the multi-function scraping massager of the present invention being used to circulate the meridians and acupoints of the back of human body;

FIG. 8 showing the meridians and acupoints of the head of human body;

FIG. 9 shows the multi-function scraping massager of the present invention being used for circulating the meridians and acupoints of the head of human body;

FIG. 10 shows the multi-function scraping massager of the present invention being applied to have a finger pressing massage;

FIG. 11 shows the multi-function scraping massager of the present invention being used as a hairpin.

### DETAILED DESCRIPTION OF THE PREFERRED EMBODIMENT

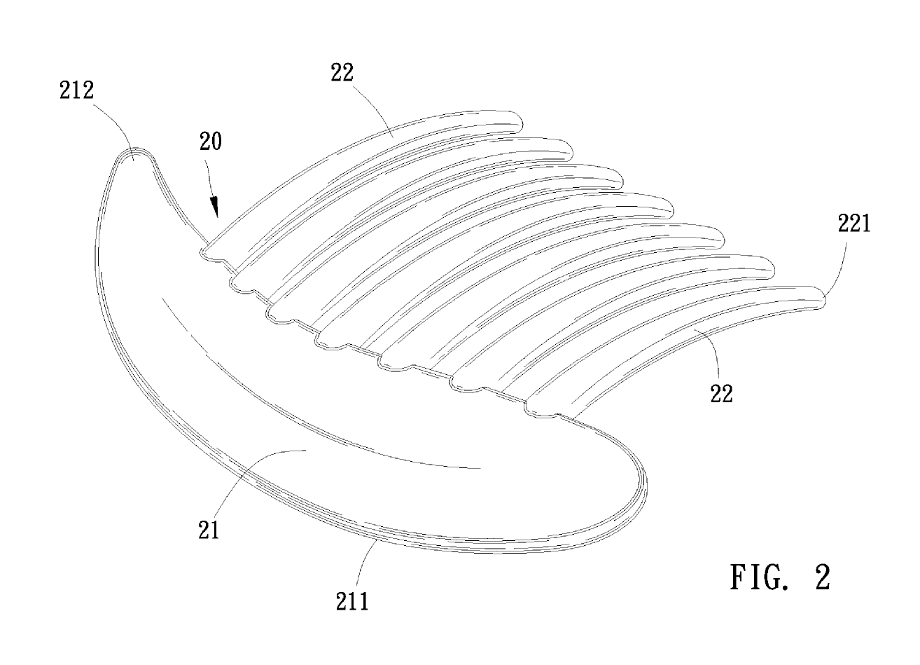

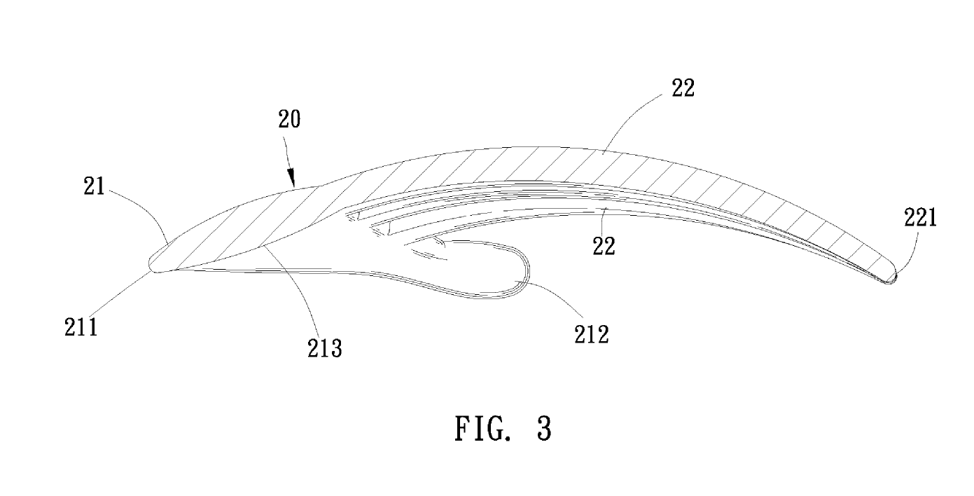

Referring to FIGS. 2 and 3, a multi-function scraping massager 20 formed of the materials having far infrared substances therein in accordance with the present invention comprises a plate 21, cross section of which is in the shape of an oval, constructed in the form of a crescent moon, and provided at the outer surface thereof with a plurality of scraping rims 211, each having a degree of curvature. At one side of the plate 21 is defined with an arc-shaped press portion 212, and the plate 21 is defined at a predetermined position thereof with an arcuate grip portion 213 for the user's comfortable griping, and is provided on its inner surface with a plurality of scraping ribs 22 which are evenly spaced apart from each other. The scraping ribs 22 are constructed in the form of a tapered arc, and are provided at the distal ends thereof with arc-shaped scraping edges 221, respectively. The distance between two respective scraping ribs 22 is approximately in response to the distance between two respective acupoints, and the radian from the individual scraping rims 211 to the scraping edge 22 corresponds to the radian of the back of the human head.

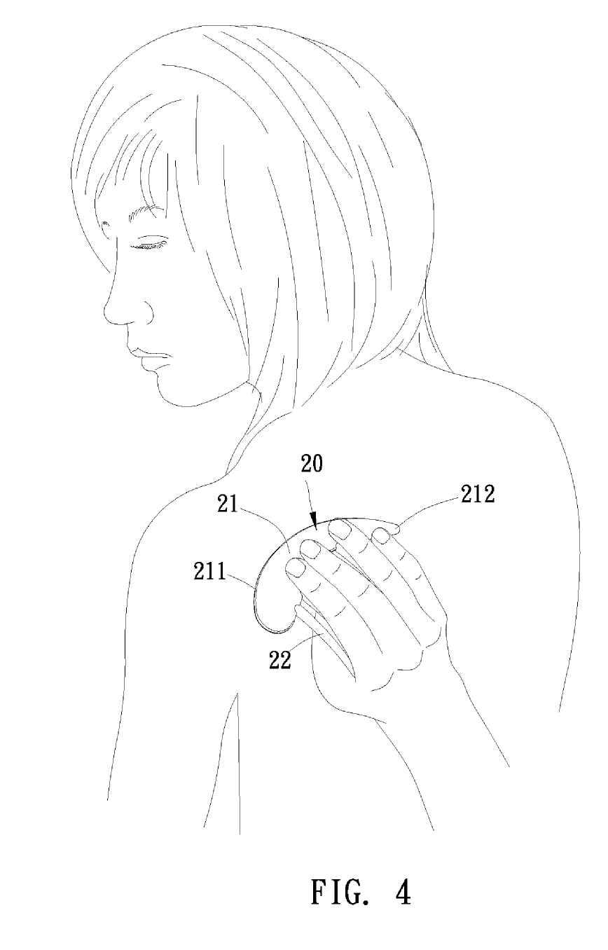

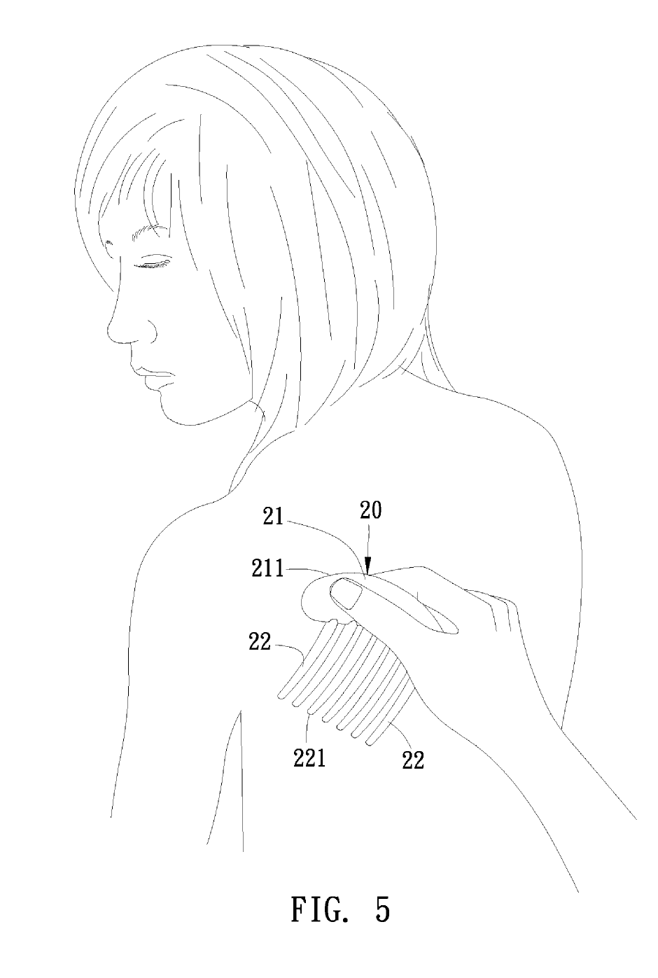

As shown in FIGS. 4-5, while in use, the user can selectively hold the multi-function scraping massager 20 at a suitable degree so that his fingers abut against the arcuate grip portion 213 of the plate 21, thus achieving an ergonomics comfortness purpose. Besides, by way of the scraping rims 211, the user can scrap his back muscle, neck and shoulder so as to have a force-saving scraping therapy, and to prevent an operational damage, and since the massager 20 is formed of the materials having far infrared substances therein, efficiently improving the blood circulation.

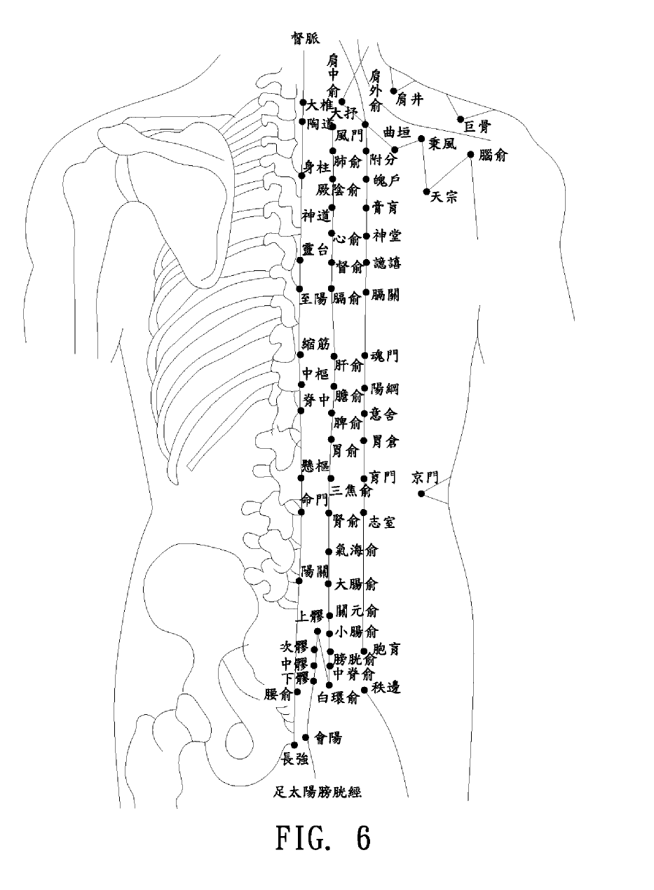

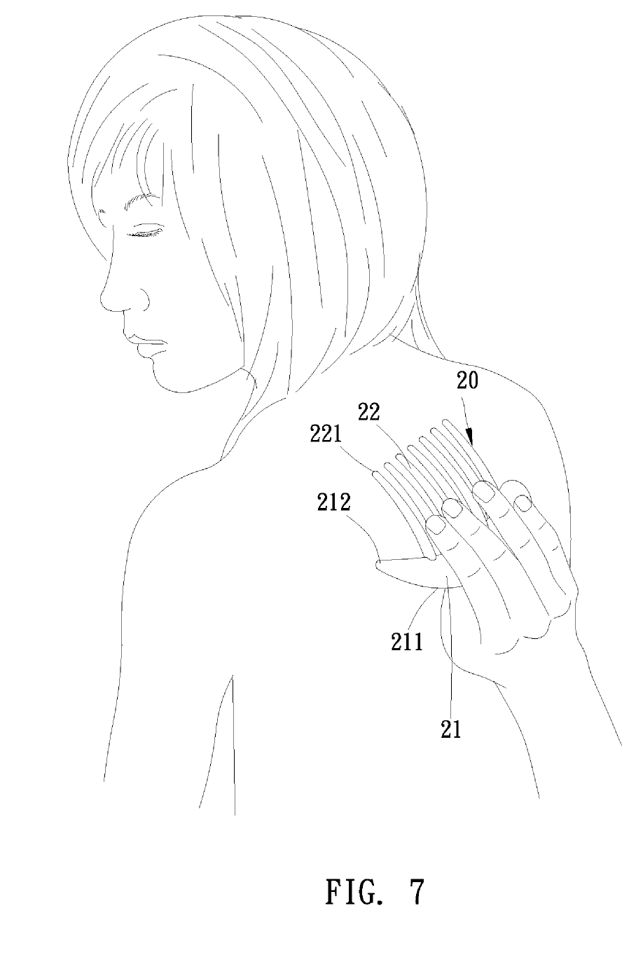

With reference to FIGS. 6-7, if the user is desired to circulate and comfort the meridians of his back, he holds the plate 21 by one hand and makes the scraping ribs 22 face his back, then by using the scraping edges 221 of the distal ends of the spaced scraping ribs 22 to scrap along the meridians of his back repeatedly, such that an efficient meridian and blood circulation can be obtained.

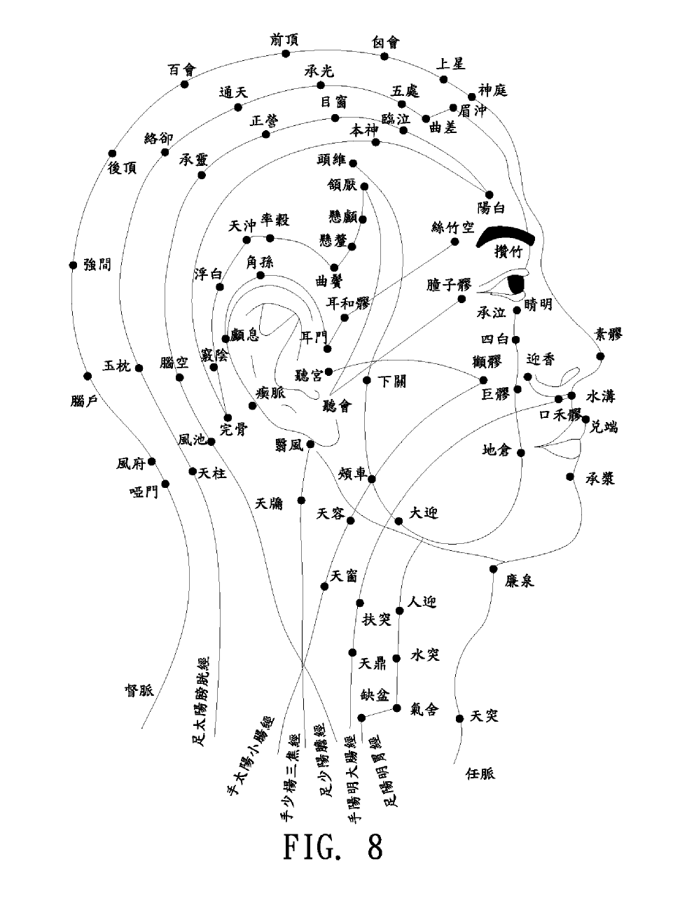

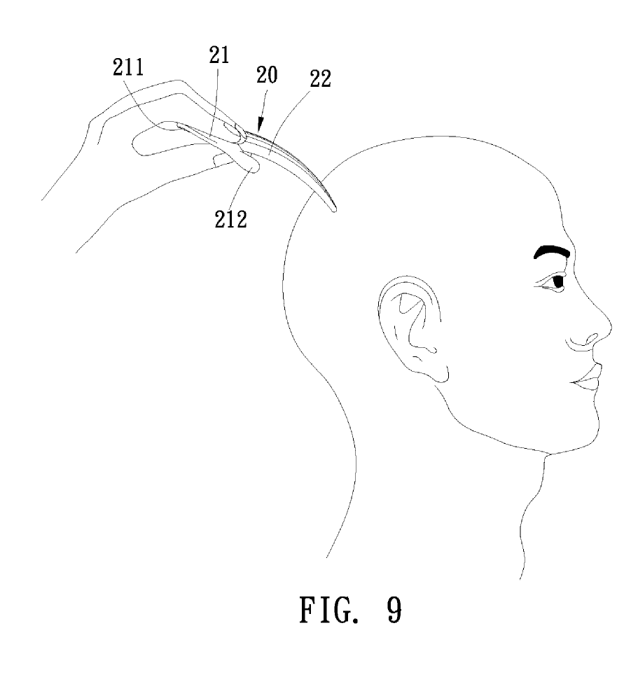

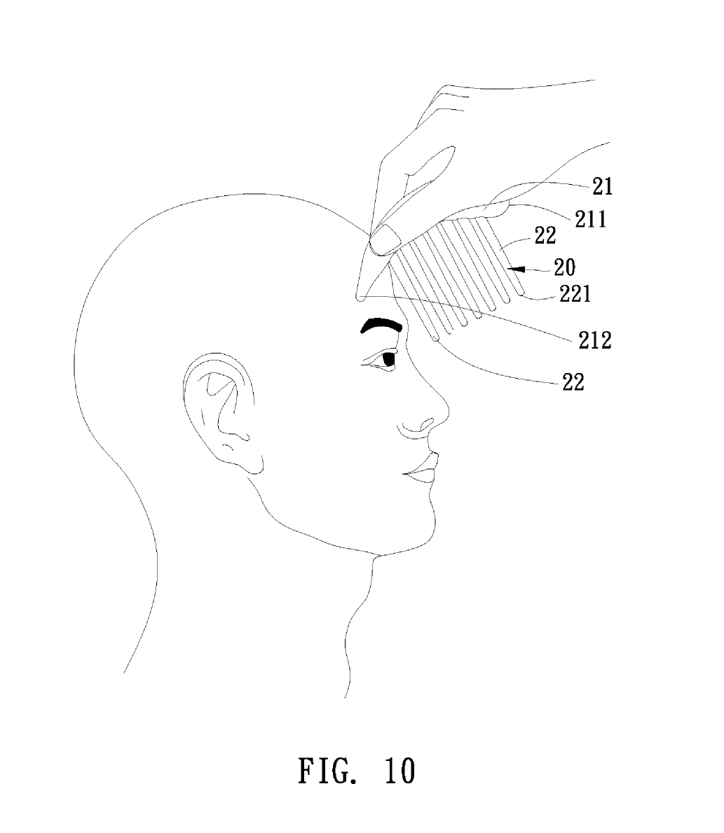

As shown in FIGS. 8-10, if the user is desired to circulate and comfort the meridians of his head, he holds the plate 21 by one hand and makes the scraping ribs 22 face his head, and then by using the scraping edges 221 of the distal ends of the spaced scraping ribs 22 to scrap along the meridians of his head repeatedly, thus having an efficient meridian and blood circulation of his head. Likewise, if desiring to have a finger pressing massage by using the multi-function scraping massager 20, the user holds the plate 21 by one hand and makes the press portion 212 presses against and deeply massages his head or any other acupoints, hence having a good finger pressing massage.

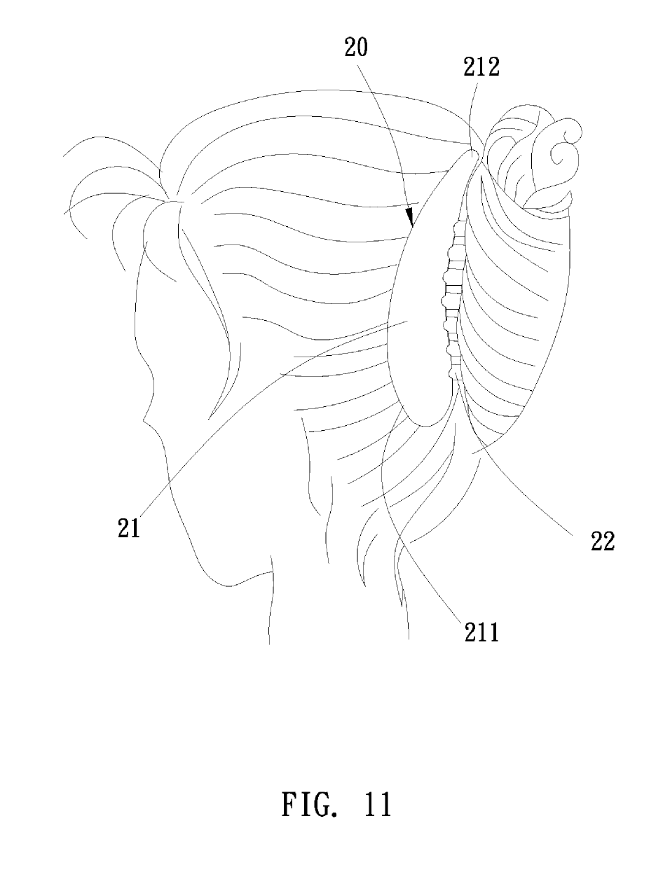

As shown in FIG. 11, because the radian from the individual scraping rims 211 to the scraping edge 22 corresponds to the radian of the back of human head, if the user has long hairs, the multi-function scraping massager 20 can also be used as a hairpin. Furthermore, since the scraping massager 20 is formed of the materials having far infrared substances therein, it releases healthy far infrared, thereby improving the blood circulation.

It is concluded from the above-mentioned structure that the multi-function scraping massager of the present invention contains the following advantages:

First, the scraping massager of the present invention has many functions, such as scraping, finger pressing massage and meridians circulation and the like.

Second, because the plate 21 is defined at a predetermined position thereof with an arcuate grip portion 213 for the user's comfortable griping, while in use, the user can selectively hold the multi-function scraping massager 20 at a suitable degree so that his fingers abut against the arcuate grip portion 213 of the plate 21, thus achieving an ergonomics comfortness purpose.

Third, at one side of the plate 21 is provided with an arc-shaped press portion 212 for accommodation to different acupoint positions, and to a concavity between two bones, such that the user is allowed to apply the present invention to have a deep massage of his body, and to prevent the operational fatigue or damage.

Fourth, because the radian from the individual scraping rims 211 to the scraping edge 22 corresponds to the radian of the back of the human head, if the user has long hairs, the multi-function scraping massager 20 can also be used as a hairpin.

Fifth, since the massager is formed of the materials having far infrared substances therein, efficiently improving the blood circulation, releasing muscular pains and fatigues. Likewise, it also releases healthy far infrared to improve the body's health.

Finally, the distance between two respective scraping ribs 22 is approximately in response to the distance between two respective acupoints, hence a number of meridians of the body can be simultaneously massaged so as to have a meridian circulation effect.

While we have shown and described various embodiments in accordance with the present invention, it should be clear to those skilled in the art that further embodiments may be made without departing from the scope of the present invention.

What is claimed is:

1. A multi-function scraping massager comprising:
a plate provided at the outer surface thereof with a plurality of scraping rims, each having a degree of curvature, at one side of said plate being defined with an arc-shaped press portion, and said plate being provided on its inner surface with a plurality of scraping ribs which are evenly spaced apart from each other.

2. The multi-function scraping massager as claimed in claim 1, wherein said plate is constructed in the form of a crescent moon.

3. The multi-function scraping massager as claimed in claim 1, wherein said plate is defined at a predetermined position thereof with an arcuate grip portion for the user's comfortable griping.

4. The multi-function scraping massager as claimed in claim 1, wherein said scraping ribs are provided at the distal ends thereof with arc-shaped scraping edges, respectively.

5. The multi-function scraping massager as claimed in claim 1, wherein said massager is formed of the materials having far infrared substances therein.

6. The multi-function scraping massager as claimed in claim 1, wherein the cross section of said plate is in the shape of an oval.

7. The multi-function scraping massager as claimed in claim 1, wherein the distance between two respective scraping ribs is approximately in response to the distance between two respective acupoints.
